(19) United States
(12) Patent Application Publication
(10) Pub. No.: US 2026/0009773 A1
(43) Pub. Date: Jan. 8, 2026

(54) CHROMATOGRAPH SYSTEM

(71) Applicant: SHIMADZU CORPORATION, Kyoto (JP)

(72) Inventor: Takuya YONEKURA, Kyoto (JP)

(73) Assignee: SHIMADZU CORPORATION, Kyoto (JP)

(21) Appl. No.: 19/254,775

(22) Filed: Jun. 30, 2025

(30) Foreign Application Priority Data
Jul. 4, 2024 (JP) 2024-107966

(51) Int. Cl. G01N 30/24; G01N 30/02; G01N 30/30; G01N 30/32; G01N 30/64; G01N 30/88; G01N 30/96

(52) U.S. Cl. CPC G01N 30/24; G01N 30/30; G01N 2030/027; G01N 2030/324; G01N 2030/326; G01N 2030/645; G01N 2030/889; G01N 2030/965

(57) ABSTRACT

A chromatograph system includes a liquid delivering pump that delivers a mobile phase, an autosampler that injects a sample into the mobile phase downstream of the liquid delivering pump, a separation column that is located downstream of the autosampler and separates components in the sample injected into the mobile phase by the autosampler a detector that has a detector cell provided downstream of the separation column and detects components in the eluent flowing through the detector cell, a plurality of sensors that measure physical quantities related to the chromatograph system, an analyzability determination unit that, during an analysis preparation period for performing sample analysis, determines whether or not the chromatograph system is in an unanalyzable state in which a detector signal output from the detector deviates from a threshold range set for the output signal during a predetermined time, and a cause identification unit configured to, when the analyzability determination unit determines that the chromatograph system is in the unanalyzable state, and when the sensors include an unstable sensor that outputs a value determined to be in an unstable state based on a preset criterion for each of the sensors, present information related to the unstable sensor to a user as a cause of the unanalyzable state.

### TECHNICAL FIELD

The present invention relates to a chromatograph system.

### BACKGROUND ART

A chromatograph system includes a liquid delivering pump, an autosampler, an analytical column, and a detector. In particular, an ion chromatograph system includes a suppressor in addition to these components, and includes an electrical conductivity detector as the detector (see Patent Literature 1). The suppressor is provided upstream of the electrical conductivity detector to remove unnecessary ions in the eluent from the separation column. By removing unnecessary ions in the eluent by the suppressor, the electrical conductivity of the eluent is lowered, the baseline of the detector signal of the electrical conductivity detector is lowered, and highly sensitive ion analysis becomes possible.

### CITATION LIST

### Patent Literature

Patent Literature 1: Japanese Unexamined Patent Application Publication No. 2024-035932

### SUMMARY OF INVENTION

### Problem to be Solved by the Invention

In a chromatograph system, fluctuations in the baseline of the detector signal output by the detector affect the analysis results, so analysis cannot be performed unless the detector signal is stable. Therefore, it is necessary to wait until the detector signal becomes stable and then start the analysis.

If the detector signal does not stabilize for a long period of time, analysis cannot be performed for a long period of time. In particular, in an ion chromatograph system, the electrical conductivity of the eluent measured by the electrical conductivity detector fluctuates due to various factors, so it is not easy for the user to identify the cause of the inability to perform analysis.

The present invention has been made in view of the above problems, and an object thereof is to make it easier to identify the cause of a state in which analysis cannot be performed in a chromatograph system.

### Means for Solving the Problem

A chromatograph system according to the present invention includes:
a liquid delivering pump that delivers a mobile phase;
an autosampler that injects a sample into the mobile phase downstream of the liquid delivering pump;
a separation column that is located downstream of the autosampler and separates components in the sample injected into the mobile phase by the autosampler;
a detector that has a detector cell provided downstream of the separation column and detects components in the eluent flowing through the detector cell;
a plurality of sensors that measure physical quantities related to the chromatograph system;
an analyzability determination unit that determines whether or not the chromatograph system is in an unanalyzable state in which a detector signal output from the detector deviates from a threshold range set for the output signal during a predetermined time during an analysis preparation period for performing sample analysis; and
a cause identification unit configured to, and when the sensors include an unstable sensor that outputs a value determined to be in an unstable state based on a preset criterion for each of the sensors, present information related to the unstable sensor to a user as a cause of the unanalyzable state.

In a chromatograph system, the detector signal output from the detector does not stabilize unless all of a plurality of factors related to analysis, such as the flow rate of the mobile phase, the temperature of the analytical column, the temperature of the detector cell of the detector, and the room temperature, are stable. In particular, in an ion chromatograph system, for example, if the suppressor current and voltage change due to deterioration of a power supply device or electrodes in the suppressor, and ion exchange between the eluent and a suppressor solution in the suppressor is not performed normally, the electrical conductivity of the eluent measured by the electrical conductivity detector changes, and the detector signal becomes unstable. Further, if the temperature of the detector cell of the electrical conductivity detector changes by 1° C., the electrical conductivity changes by several percent, so if the temperature of the detector cell is not stable, the detector signal also becomes unstable. Conversely, if the detector signal of the electrical conductivity detector is stable, it can be said that all such factors related to analysis are also stable, so it can be determined that the state is ready for analysis. In the present invention, it is determined whether the system state is an unanalyzable state based on whether or not the detector signal output from the detector is stable, and when the system state is an unanalyzable state, the cause of the system state being an unanalyzable state is identified based on whether or not the measured values of a plurality of sensors provided in the system are stable, and presented to the user.

### Effects of the Invention

According to the chromatograph system of the present invention, during the analysis preparation period for performing sample analysis, it is determined whether or not the system is in an unanalyzable state in which the detector signal output from the detector deviates from a threshold range set for the output signal during a predetermined time, and when it is determined that the system is in the unanalyzable state, and when the sensors include an unstable sensor that outputs a value determined to be in an unstable state based on a preset criterion for each of the sensors, present information related to the unstable sensor to a user as a cause of the unanalyzable state.

### BRIEF DESCRIPTION OF DRAWINGS

FIG. 1 is a schematic configuration diagram showing an embodiment of a chromatograph system.

FIG. 2 is a flowchart schematically showing an example of a series of flows related to analysis in the embodiment.

FIG. 3 is a flowchart showing an example of an analyzability determination operation in the embodiment.

### DETAILED DESCRIPTION OF EMBODIMENTS

Hereinafter, an embodiment of a chromatograph system according to the present invention will be described with reference to the drawings. Here, an ion chromatograph system will be described as an example of a chromatograph system.

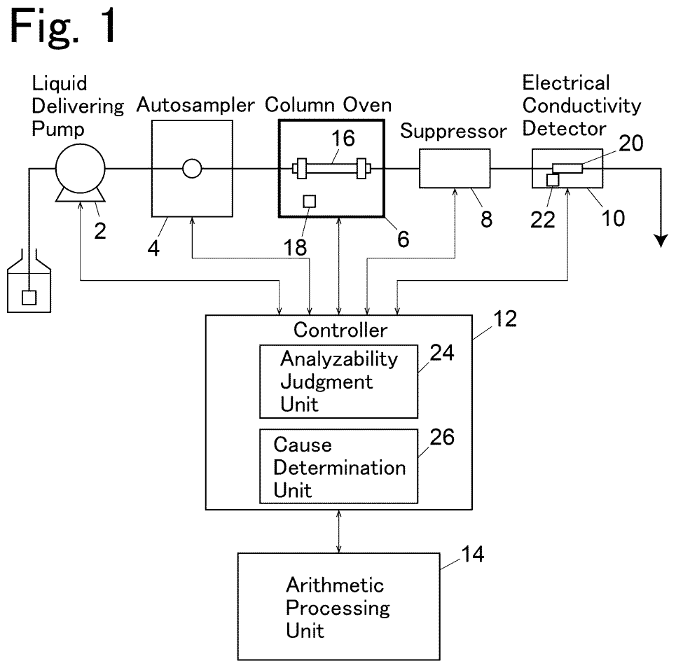

As shown in FIG. 1, the ion chromatograph system of this embodiment includes a liquid delivering pump 2, an autosampler 4, a column oven 6, a suppressor 8, an electrical conductivity detector 10, a controller 12, and an arithmetic processing unit 14.

An autosampler 4 is fluidly connected downstream of a liquid delivering pump 2 that delivers a mobile phase. The autosampler 4 injects a sample into the mobile phase sent by the liquid delivering pump 2.

The column oven 6 houses a separation column 16 therein. It houses a temperature sensor 18. The separation column 16 is fluidly connected downstream of the autosampler 4, and ion components in the sample injected into the mobile phase by the autosampler 4 are separated in the separation column 16. The column oven 6 includes, in addition to the temperature sensor 18 that detects the temperature of the space housing the separation column 16, a heater and a fan (both not shown) for adjusting the temperature of the space housing the separation column 16, and the outputs of the heater and the fan are controlled so that the temperature detected by the temperature sensor 18 is maintained constant at a set temperature.

The suppressor 8 is fluidly connected downstream of the separation column 16 and removes unnecessary ions in the eluent from the separation column 16.

The electrical conductivity detector 10 includes a detector cell 20 that is connected downstream of the suppressor 8 and through which the eluent flowing out from the suppressor 8 flows, and measures the electrical conductivity of the eluent flowing through the detector cell 20. The electrical conductivity detector 10 independently includes a heater (not shown) for adjusting the temperature of the detector cell 20 and a temperature sensor 22 for detecting the temperature of the detector cell 20, and the output of the heater is controlled so that the temperature of the temperature sensor 22 becomes constant. The detector cell 20 and the temperature sensor 22 may be housed in the column oven 6 in a state of being housed in a common casing.

The controller 12 manages the operations of the liquid delivering pump 2, the autosampler 4, the column oven 6, the suppressor 8, and the electrical conductivity detector 10. The controller 12 can be realized by an electronic circuit including a CPU (Central Processing Unit) and an information storage device.

The controller 12 includes an analyzability determination unit 24 and a cause identification unit 26. The analyzability determination unit 24 is configured to execute analyzability determination as to whether the system state is an analyzable state or an unanalyzable state during an analysis preparation period for executing analysis of the next sample. The cause identification unit 26 is configured to, when the analyzability determination unit 24 determines that the system state is an unanalyzable state, identify the cause of the system being in the unanalyzable state and present it to the user. The analyzability determination unit 24 and the cause identification unit 26 are functions obtained by a computer program being executed by the CPU of the controller 12. Details of the analyzability determination by the analyzability determination unit 24 and the cause identification by the cause identification unit 26 will be described later.

The arithmetic processing unit 14 is a computer device communicably connected to the controller 12. The user performs setting of analysis conditions and the like on the arithmetic processing unit 14. The arithmetic processing unit 14 transmits the analysis conditions set by the user to the controller 12. The controller 12 manages the operations of the liquid delivering pump 2, the autosampler 4, the column oven 6, the suppressor 8, and the electrical conductivity detector 10 based on the analysis conditions transmitted from the arithmetic processing unit 14. The arithmetic processing unit 14 also reads and records the detector signal of the electrical conductivity detector 10 through the controller 12, and performs chromatograph creation and the like.

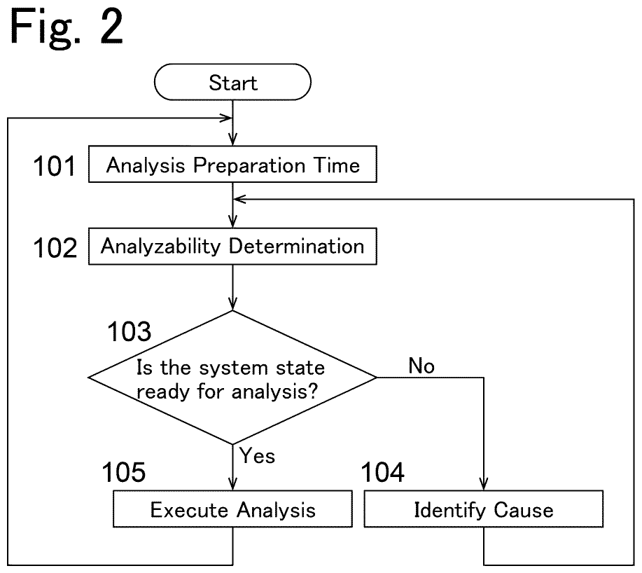

A schematic flow from the transition to the analysis preparation period for sample analysis until the analysis is executed will be described with reference to FIG. 1 and the flowchart of FIG. 2.

In this ion chromatograph system, sample analysis is automatically executed based on the result of the analyzability determination by the analyzability determination unit 24. Control of the liquid delivering flow rate of the liquid delivering pump 2, the temperature of the column oven 6, the suppressor current or voltage of the suppressor 8, and the temperature of the detector cell 20 of the electrical conductivity detector 10 is started according to preset analysis conditions, and when it is time for analysis preparation before sample analysis is executed (Step 101), the analyzability determination unit 24 of the controller 12 executes analyzability determination (Step 102). In the analyzability determination, it is determined whether the state of this ion chromatograph system (system state) is an analyzable state in which sample analysis can be executed or an unanalyzable state in which sample analysis cannot be executed (Step 103).

When the analyzability determination unit 24 determines that the system state is an unanalyzable state (Step 103: No), the cause identification unit 26 identifies the cause of the unanalyzable state and presents it to the user (Step 104). The analyzability determination by the analyzability determination unit 24 (Steps 102 and 103) and the cause identification by the cause identification unit 26 (Step 104) are repeatedly executed until the analyzability determination unit 24 determines that the system state is an analyzable state. When the analyzability determination unit 24 determines that the system state is an analyzable state (Step 103: Yes), the controller 12 determines that the analysis preparation is complete, causes the autosampler 4 to execute sample injection, and starts sample analysis (Step 105).

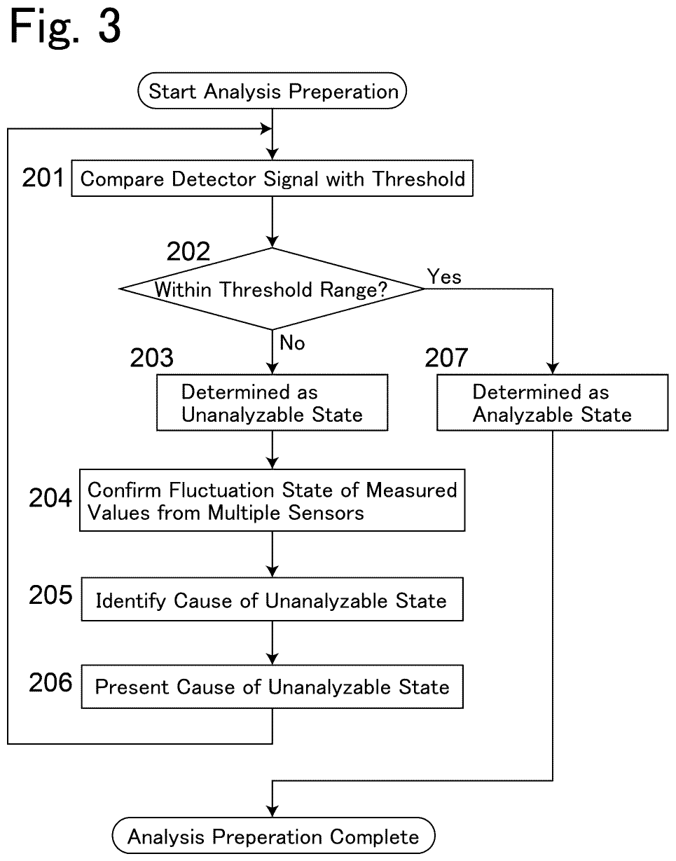

Next, analyzability determination and cause identification will be described with reference to FIG. 1 and the flowchart of FIG. 3.

When the analysis preparation period comes and analysis preparation is started, the analyzability determination unit 24 starts analyzability determination. In the analyzability determination, the analyzability determination unit 24 compares the detector signal of the electrical conductivity detector 10 with preset upper and lower threshold values (Step 201), and performs state determination as to whether or not the detector signal has continuously remained within the threshold range during a predetermined time (Step 202). If the detector signal does not continuously remain within the threshold range during the predetermined time, that is, if the detector signal is in an unstable state in which it deviates from the threshold range during the predetermined time (Step 202: No), the analyzability determination unit 24 determines that the system state is an unanalyzable state (Step 203). On the other hand, if the detector signal has become a stable state in which it continuously remains within the threshold range during the predetermined time (Step 202: Yes), the analyzability determination unit 24 determines that the system state is an analyzable state (Step 207). When the analyzability determination unit 24 determines that the system state is an analyzable state, the controller 12 determines that analysis preparation is complete and starts sample analysis.

Here, the analyzability determination unit 24 performs the state determination as to whether or not the detector signal is within the threshold range, but the electrical conductivity detector 10 may perform the state determination. When the electrical conductivity detector 10 performs the state determination, the electrical conductivity detector 10 outputs a stable signal indicating a stable state to the controller 12 if the detector signal is in a stable state, and outputs an unstable signal indicating an unstable state to the controller 12 if the detector signal is in an unstable state, whereby the analyzability determination unit 24 can recognize the state of the detector signal.

In the state determination of the detector signal, the moving average value of the detector signal (measured value of electrical conductivity) or the maximum value and the minimum value of the differential value of the moving average value can be compared with a predetermined threshold range. The threshold range may be an absolute value (for example, the difference between the maximum value and the minimum value is 0.01 μS/cm or less) or a value obtained from a ratio to a reference value (for example, 10% or less of the detector signal (reference value) when the electrical conductivity detector 10 is auto-zeroed).

If the detector signal is in an unstable state (Step 202: No), the analyzability determination unit 24 determines that the system state is an unanalyzable state (Step 203). When the analyzability determination unit 24 determines that the system state is an unanalyzable state, the cause identification unit 26 checks the fluctuation state of each physical quantity related to the system, such as room temperature, the liquid delivering flow rate of the liquid delivering pump 2, the temperature of the separation column 16 detected by the temperature sensor 18 of the column oven 4, the suppressor current or voltage of the suppressor 8, and the temperature of the detector cell 20 detected by the temperature sensor 22 of the electrical conductivity detector 10, that is, whether each physical quantity is in a stable state or an unstable state based on a preset criterion for each (Step 204). The determination of whether each physical quantity such as the temperature of the separation column 16, the suppressor current or voltage, and the temperature of the detector cell 20 is in a stable state or an unstable state may be performed by the column oven 6, the suppressor 8, and the electrical conductivity detector 10, respectively, and signals indicating the stable state and the unstable state, respectively, may be transmitted to the controller 12. Further, the controller 12 may perform the determination of the fluctuation state of each physical quantity. The algorithm for determining the fluctuation state of each physical quantity may be the same as the algorithm for determining the state of the detector signal.

After confirming the fluctuation state of each physical quantity, the cause identification unit 26 identifies the cause of the system state being an unanalyzable state based on the fluctuation state of each physical quantity (Step 205), and presents the identified cause to the user through an information display device such as a liquid crystal display provided in the controller 12 or a liquid crystal display electrically connected to the arithmetic processing unit 14 (Step 206). For example, if the analyzability determination unit 24 determines that the system state is an unanalyzable state and the temperature of the detector cell 20 is also in an unstable state, by displaying information related to the temperature sensor 22 that measures the temperature of the detector cell 20 on the information display device, it is possible to present to the user the possibility that the instability of the temperature of the detector cell 20 is the cause of the unanalyzable state. Further, even when the room temperature is not monitored, if the analyzability determination unit 24 determines that the system state is an unanalyzable state, but all physical quantities such as the liquid delivering flow rate, the temperature of the column oven 4, the suppressor current or voltage, and the temperature of the detector cell 20 are in a stable state, it is possible to identify an element other than the physical quantities monitored by the sensors (for example, room temperature) as the cause of the unanalyzable state, and display an indication that the cause of the unanalyzable state is an element not monitored by the system (for example, a display such as “Please check the air conditioner”).

The analyzability determination by the analyzability determination unit 24 and the cause identification by the cause identification unit 26 can be repeatedly executed until the analyzability determination unit 24 determines that the system state is an analyzable state and sample analysis is started.

In the above embodiment, the analyzability determination unit 24 and the cause identification unit 26 are provided in the controller 12, but the present invention is not limited to such a form. The analyzability determination unit 24 and the cause identification unit 26 may be provided in the electrical conductivity detector 10 or the arithmetic processing unit 14.

The embodiment described above is merely an example of an embodiment of the chromatograph system according to the present invention. Embodiments of the chromatograph system according to the present invention are as follows.

An embodiment of the chromatograph system according to the present invention includes:
a liquid delivering pump that delivers a mobile phase;
an autosampler that injects a sample into the mobile phase downstream of the liquid delivering pump;
a separation column that is located downstream of the autosampler and separates components in the sample injected into the mobile phase by the autosampler;
a detector that has a detector cell provided downstream of the separation column and detects components in the eluent flowing through the detector cell;
a plurality of sensors that measure physical quantities related to the chromatograph system;
an analyzability determination unit that determines whether or not the chromatograph system is in an unanalyzable state in which a detector signal output from the detector deviates from a threshold range set for the output signal during a predetermined time during an analysis preparation period for performing sample analysis; and
a cause identification unit configured to, when the analyzability determination unit determines that the chromatograph system is in the unanalyzable state, and when the sensors include an unstable sensor that outputs a value determined to be in an unstable state based on a preset criterion for each of the sensors, present information related to the unstable sensor to a user as a cause of the unanalyzable state.
In aspect [1] of the above embodiment, the plurality of sensors include at least one of a sensor that measures room temperature, a sensor that measures the liquid delivering flow rate of the liquid delivering pump, a sensor that measures the temperature of the separation column, and a sensor that measures the temperature of the detector cell.
In aspect [2] of the above embodiment, the autosampler is configured to execute sample injection and start sample analysis immediately after the analyzability determination unit determines that the system is in an analyzable state in which the detector signal remains within the threshold range during the predetermined time. This aspect [2] can be combined with the above aspect [1].
In aspect [3] of the above embodiment, the cause identification unit is configured to, when the analyzability determination unit determines that the system is in the unanalyzable state, yet all measured values of the plurality of sensors are determined to be in a stable state based on the preset criterion for each, present information related to something other than the plurality of sensors to the user as a cause of the unanalyzable state. This aspect [3] can be combined with the above aspect [1] and/or [2].
In aspect [4] of the above embodiment, the system includes a suppressor between the separation column and the detector for removing unnecessary ion components from the eluent, the detector is an electrical conductivity detector that detects ion components in the eluent, and the plurality of sensors include a sensor that measures the current or voltage of the suppressor. This aspect [4] can be combined with the above aspects [1], [2], and/or [3].

### REFERENCE SIGNS LIST

2 Liquid delivering pump
4 Autosampler
6 Column oven
8 Suppressor
10 Electrical conductivity detector
12 Controller
14 Arithmetic processing unit
16 Separation column
18, 22 Temperature sensor
20 Detector cell
24 Analyzability determination unit
26 Cause identification unit

1. A chromatograph system, comprising:
a liquid delivering pump that delivers a mobile phase;
an autosampler that injects a sample into the mobile phase downstream of the liquid delivering pump;
a separation column that is located downstream of the autosampler and separates components in the sample injected into the mobile phase by the autosampler;
a detector that has a detector cell provided downstream of the separation column and detects components in the eluent flowing through the detector cell;
a plurality of sensors that measure physical quantities related to the chromatograph system;
an analyzability determination unit that, during an analysis preparation period for performing sample analysis, determines whether or not the chromatograph system is in an unanalyzable state in which a detector signal output from the detector deviates from a threshold range set for the output signal during a predetermined time; and
a cause identification unit configured to, when the analyzability determination unit determines that the chromatograph system is in the unanalyzable state and when the sensors include an unstable sensor that outputs a value determined to be in an unstable state based on a preset criterion for each of the sensors, present information related to the unstable sensor to a user as a cause of the unanalyzable state.

2. The chromatograph system according to claim 1, wherein the plurality of sensors include at least one of a sensor that measures room temperature, a sensor that measures a liquid delivering flow rate of the liquid delivering pump, a sensor that measures a temperature of the separation column, and a sensor that measures a temperature of the detector cell.

3. The chromatograph system according to claim 1, wherein the autosampler is configured to execute sample injection and start sample analysis immediately after the analyzability determination unit determines that the system is in an analyzable state in which the detector signal remains within the threshold range during the predetermined time.

4. The chromatograph system according to claim 1, wherein the cause identification unit is configured to, when the analyzability determination unit determines that the chromatograph system is in the unanalyzable state, yet all measured values of the plurality of sensors are determined to be in a stable state based on the preset criterion for each, present information related to something other than the plurality of sensors to a user as a cause of the unanalyzable state.

5. The chromatograph system according to claim 1, further comprising a suppressor between the separation column and the detector for removing unnecessary ion components from the eluent, wherein the detector is an electrical conductivity detector that detects ion components in the eluent, and
the plurality of sensors include a sensor that measures a current or voltage of the suppressor.
